(19) United States
(12) Patent Application Publication
(10) Pub. No.: US 2016/0175996 A1
(43) Pub. Date: Jun. 23, 2016

(54) REPAIR MATERIAL PREFORM

(71) Applicant: UNITED TECHNOLOGIES CORPORATION, Hartford, CT (US)

(72) Inventors: PHILIP R. BELANGER, ACTON, ME (US); PAUL M. LUTJEN, KENNEBUNKPORT, ME (US); RICHARD K. HAYFORD, CAPE NEDDICK, ME (US)

(73) Assignee: UNITED TECHNOLOGIES CORPORATION, HARTFORD, CT (US)

(21) Appl. No.: 14/643,703

(22) Filed: Mar. 10, 2015

Related U.S. Application Data
(60) Provisional application No. 61/975,543, filed on Apr. 4, 2014.

(51) Int. Cl. B23P 6/00; B22D 21/00; C22C 19/03

(52) U.S. Cl. CPC B23P 6/005; C22C 19/03; B22D 21/005

(57) ABSTRACT

A structural element for repairing a damaged component comprising a shaped cavity configured to receive the damaged component and a repair material, the shaped cavity comprising a material having a first melting point and the repair material comprising a material having a second melting point that is lower than the first melting point. The shaped cavity may comprise a preform for the damaged component. The preform may comprise a mold configured to reconstruct the shape of the damaged component. The repair material may comprise a first material and a second material, the second material having a melting point that is lower than the first material. The repair material may comprise a Nickel-Boron composition. The repair material may have a melting point that is approximately 40 degrees Fahrenheit lower than the melting point of the damaged component.

### CROSS-REFERENCE TO RELATED APPLICATIONS

This application is a nonprovisional of, and claims priority to, and the benefit of U.S. Provisional Application No. 61/975,543, entitled “REPAIR MATERIAL PREFORM,” filed on Apr. 4, 2014, which is hereby incorporated by reference in its entirety.

### FIELD

The present disclosure relates to the repair of components, such as seals, within gas turbine engines, and more particularly to the repair of portions of a blade outer air seal assembly (“BOAS” assembly) located within a gas turbine engine.

### BACKGROUND

Gas turbine engines generally include a compressor to pressurize inflowing air, a combustor to burn a fuel in the presence of the pressurized air, and a turbine to extract energy from the resulting combustion gases. The turbine may include multiple rotatable turbine blade arrays separated by multiple stationary vane arrays. A turbine blade array may be disposed radially inward of an annular BOAS assembly. Frequently, portions of the BOAS assembly—such as seals within the assembly—may be damaged, e.g., by abrasion, impact or oxidation erosion.

### SUMMARY

In various embodiments, a structural element for repairing a damaged component is disclosed. The structural element may comprise a shaped cavity configured to receive the damaged component and a repair material. The shaped cavity may comprise a material having a first melting point and the repair material comprising a material having a second melting point that is lower than the first melting point. Additionally, the repair material may comprise a first material and an additive material. The shaped cavity may, as well, comprise a preform for the damaged component, such as a mold configured to reconstruct the shape of the damaged component. To this end, the repair material may comprise a nickel-boron or cobalt-boron composition, which may have a melting point that is approximately 40 degrees Fahrenheit lower than the melting point of the damaged component.

The foregoing features and elements may be combined in various combinations without exclusivity, unless expressly indicated otherwise. These features and elements as well as the operation thereof will become more apparent in light of the following description and the accompanying drawings. It should be understood, however, the following description and drawings are intended to be exemplary in nature and non-limiting.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the drawing figures, wherein like numerals denote like elements.

FIG. 1A illustrates, in accordance with various embodiments, a cross-sectional view of a jet engine;

FIG. 1B illustrates, in accordance with various embodiments, a cross-sectional view of a turbine portion of a jet engine;

FIG. 1C illustrates, in accordance with various embodiments, a perspective view of a segment of a BOAS assembly having a sealing interface that has been damaged;

FIG. 1D illustrates, in accordance with various embodiments, a perspective view of a damaged sealing interface;

FIG. 2A illustrates, in accordance with various embodiments, a shaped cavity;

FIG. 2B illustrates, in accordance with various embodiments, a perspective view of a portion of a BOAS assembly having a sealing interface that has been repaired; and

FIG. 3 illustrates, in accordance with various embodiments, a process for repairing a damaged component.

### DETAILED DESCRIPTION

The detailed description of exemplary embodiments herein makes reference to the accompanying drawings, which show exemplary embodiments by way of illustration and their best mode. While these exemplary embodiments are described in sufficient detail to enable those skilled in the art to practice the inventions, it should be understood that other embodiments may be realized and that logical and mechanical changes may be made without departing from the spirit and scope of the inventions. Thus, the detailed description herein is presented for purposes of illustration only and not for limitation. For example, any reference to singular includes plural embodiments, and any reference to more than one component or step may include a singular embodiment or step. Also, any reference to attached, fixed, connected or the like may include permanent, removable, temporary, partial, full and/or any other possible attachment option.

In addition, although the description provided herein may focus on a particular aircraft component (e.g., a sealing interface comprising a portion of a BOAS assembly), those of ordinary skill will appreciate that the methods and techniques for repairing damaged components may apply to a wide variety of components.

As used herein, “aft” refers to the direction associated with the tail (e.g., the back end) of an aircraft, or generally, to the direction of exhaust of the gas turbine. As used herein, “forward” refers to the directed associated with the nose (e.g., the front end) of an aircraft, or generally, to the direction of flight or motion.

Jet engines often include one or more stages of BOAS and/or vane assemblies. Each BOAS and/or vane assembly may comprise one or more sections or segments. In some embodiments the BOAS are detachably coupled to an axially adjacent vane assembly, in other embodiments, the BOAS is integral with an axially adjacent vane assembly, in either case and without loss of generality, the present application refers to these as BOAS. In some applications, the BOAS is also referred to as a static turbine shroud. A segment of a BOAS assembly may be disposed radially outward of a turbine blade and/or a plurality of turbine blades relative to an engine axis. A BOAS assembly may thus comprise an annular structure comprising a plurality of BOAS assembly segments, each BOAS assembly segment disposed radially about one or more of a plurality of turbine blades, each of which may rotate, during operation, within the BOAS assembly.

Each BOAS segment may couple to an adjacent BOAS segment to form the annular BOAS assembly described above by way of a plurality of sealing interfaces. Over time, some of these sealing interfaces may erode or otherwise wear away (e.g., via an oxidation erosion process such that a seal formed between one or more consecutive BOAS segments may fail to contain the pressure and temperature of the combustion gasses within the high pressure turbine. This loss of pressure may result, in addition to damage to the BOAS assembly, in a loss of fuel efficiency.

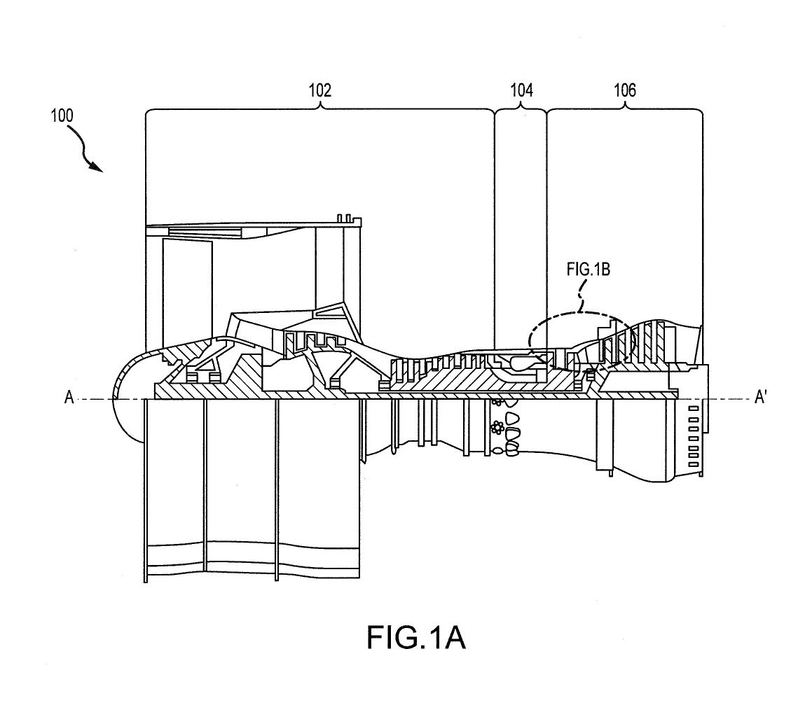

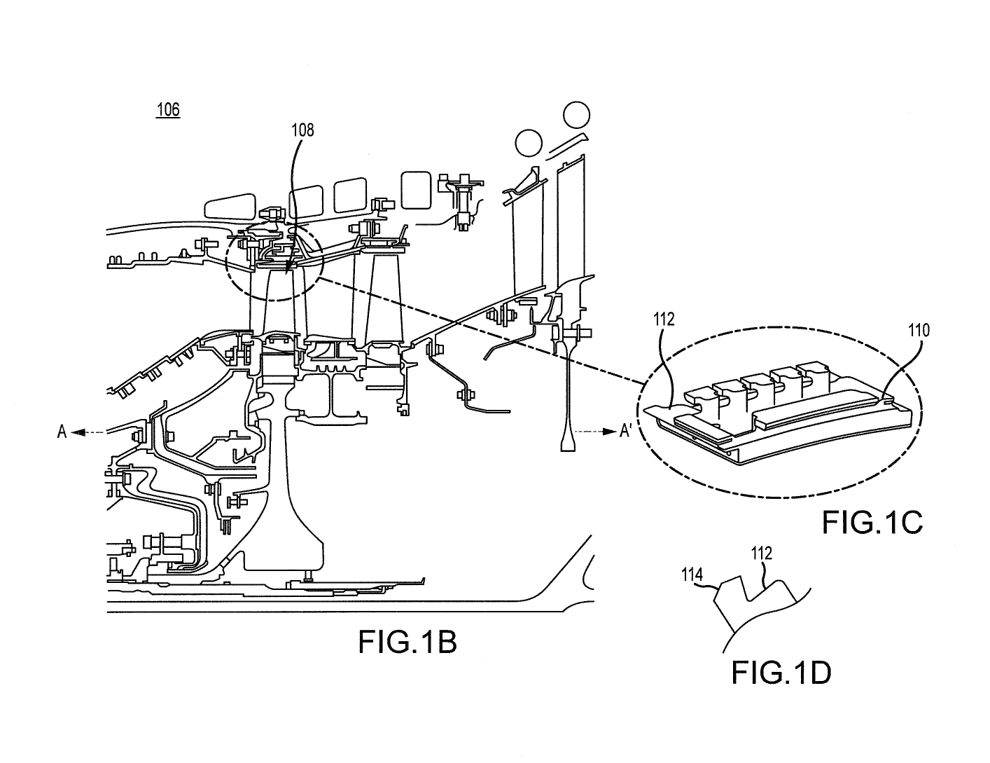

Accordingly, with reference to FIG. 1A, a jet engine (e.g., a gas turbine engine) 100 is shown. The jet engine 100 may extend, from forward to aft, along the central axis marked A-A′. In general terms, a jet engine may comprise a compressor section 102, a combustion chamber 104, and a turbine section 106. Air may flow through the compressor section 102 (which may comprise a plurality of compressor blades) and into the combustion chamber 104, where the air is mixed with a fuel source and may be ignited to produce hot combustion gasses. These hot combustion gasses may drive a series of turbine blades within the turbine section 106, which in turn drive, for example, one or more compressor section blades mechanically coupled thereto.

FIG. 1B shows an area within the turbine section 106 that includes a BOAS assembly 108. The BOAS assembly 108 may comprise a plurality of BOAS segments 110, as described above and as shown, at FIG. 1C. Each segment 110 may couple to an adjacent segment to form an annular BOAS assembly that is concentrically situated about a plurality of turbine blades, each radially extending away from the axis A-A′.

As described above, and as shown with respect to FIG. 1C, a BOAS segment 110 may comprise a sealing interface 112. The sealing interface 112 may be damaged by abrasion, impact or erode over time (e.g., where the sealing interface 112 comprised of nickel or cobalt alloy, via abrasion, impact or oxidation erosion process), such that the interface may form an incomplete seal with an adjacent sealing interface (e.g., comprising an adjacent BOAS segment).

A damaged sealing interface 112 is shown, for clarity, at FIG. 1D. As shown, the edge 114 of the sealing interface 112 may erode or abrade away such that the sealing interface is incomplete or altered from its original form. As this occurs, and during operation, air may bleed from the turbine, resulting in a loss of efficiency.

This sealing interface 112 may, in various embodiments, be repaired by healing or replacing, as described herein, the eroded or lost material with a repair material such that the lost edge or portion 114 of the sealing interface 112 may be rebuilt.

In general, a repair material may comprise a combination of two or more materials. For example, in various embodiments, a repair material may comprise a first material, which may be referred to herein as the “parent material” and a second or additive material, which may lower the melting temperature of the parent material. In various embodiments, the parent material may comprise a material that is the same as the material comprising the part being repaired. For example, in various embodiments, the parent material (as well as the sealing interface 112) may comprise largely of nickel or cobalt alloy, while the additive material may comprise boron. As described, the boron (the additive material) may lower the melting temperature of the nickel (the parent material) by approximately 40 degrees Fahrenheit. In various embodiments, the repair material may include a variety of binders and other inclusions such that the repair material may comprise a gel, a paste, a powder, and/or the like.

Typically, for the parent material within the repair material to form a metallurgical bond with the parent material comprising the remaining portion of the sealing interface 112, it is necessary that the additive material (e.g., boron) leach or diffuse into the parent material in the remaining portion of the damaged component 112. Thus, although the application of repair material to a damaged component may repair the component, the component's melting temperature, once repaired, may also be reduced by the introduction of boron to its composition.

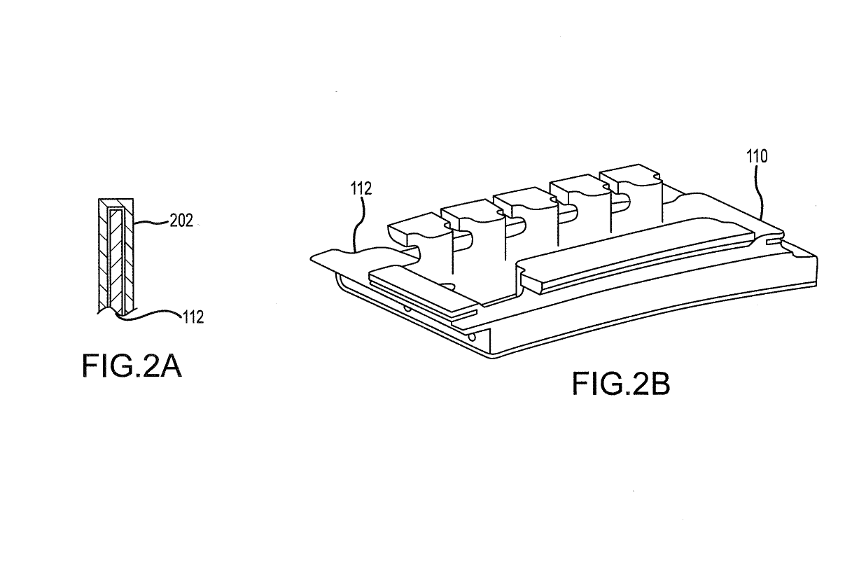

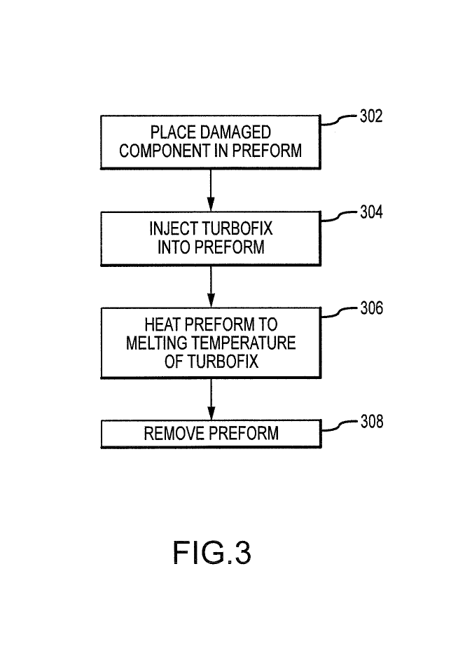

With reference to FIG. 2A and FIG. 3 (describing a repair process 300), however, insertion of a damaged component, such as the interface 112, into a structural element comprising a shaped cavity 202 may prevent or reduce the effect described above. Specifically, where the shaped cavity 202 comprises parent material as well, the additive material in the repair material may be encouraged to diffuse into the shaped cavity 202 rather than the parent material comprising the component to be repaired, such as the sealing interface 112. Further, even where the shaped cavity does not comprise parent material (e.g., where the shaped cavity comprises sheet metal), boron may migrate during a diffusion process into the shaped cavity 202 (step 304), rather than the damaged component.

In various embodiments, then, a damaged component, such as the sealing interface 112, may be overlaid or inserted within the shaped cavity 202 (step 302), and, as part of a repair process, repair material comprising the parent material and an additive material may be injected into the shaped cavity 202 (step 304). The shaped cavity 202 may comprise any shape that is suitable for repairing a particular component. Thus, the shaped cavity 202 may be referred to herein as a “preform” in the sense that it may comprise a mold capable of receiving a damaged component and repair material to reconstruct the shape of the original component. For example, as shown, the shaped cavity 202 may comprise a rectangular shape in the event, as here, that a sealing interface 112 is in need of repair. Further, in various embodiments, parent material may be applied using a variety of techniques as well as before and/or after the shaped cavity 202 is installed.

Accordingly, having injected repair material into the shaped cavity 202, a diffusion process may be initiated (e.g., by the application of heat to the shaped cavity 202) (step 306). As the shaped cavity 202 is heated to the melting temperature of the repair material (which, again, may be approximately 40 degrees Fahrenheit lower than the melting point of the parent material comprising the damaged component and the shaped cavity 202), the parent material in the repair material may melt to form a metallurgical bond with the parent material comprising the damaged part (e.g., the sealing interface 112), while the additive material (e.g., Boron) may diffuse into the shaped cavity 202. Thus, the repaired component may retain its original melting point and temperature resistance. In various embodiments, the additive material may comprise any cobalt and/or nickel alloy.

In various embodiments, after repairs are completed, the shaped cavity 202 may be removed by any suitable means—e.g., it may be machined away, chemically removed, and the like (step 308). In addition, in various embodiments, as the additive material is diffused into the shaped cavity 202, the melting point of the shaped cavity 202 may be reduced and therefore itself melt away from the reconstructed component, such as the sealing interface 112. A reconstructed sealing surface 112 is shown mounted to a BOAS segment 110 in FIG. 2B. Furthermore, the repair process 300 may, in various embodiments, be especially useful in the restoration of tall and/or thin components (e.g., approximately 0.040 inches (or 0.1016 centimeters) and larger).

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the inventions. The scope of the inventions is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching is used throughout the figures to denote different parts but not necessarily to denote the same or different materials.

Systems, methods and apparatus are provided herein. In the detailed description herein, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f), unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A structural element for repairing a damaged component comprising:
a shaped cavity configured to receive the damaged component and a repair material, wherein the damaged component melts at a first temperature and the repair material melts at a second temperature that is lower than the first temperature.

2. The structural element of claim 1, wherein the repair material comprises a first material and an additive material.

3. The structural element of claim 1, wherein the shaped cavity comprises a preform for the damaged component.

4. The structural element of claim 3, wherein the preform comprises a mold configured to reconstruct the shape of the damaged component.

5. The structural element of claim 1, wherein the repair material comprises a first material and a second material, the second material having a melting point that is lower than the first material.

6. The structural element of claim 1, wherein the repair material comprises a nickel-boron composition.

7. The structural element of claim 1, wherein the repair material has a melting point that is approximately 40 degrees Fahrenheit lower than the melting point of the damaged component, the damaged component comprising the structural element.

8. A method for repair comprising:
placing a damaged component within a shaped cavity;
applying a repair material within the shaped cavity; and
applying heat to the shaped cavity to repair the damaged component.

9. The method of claim 8, further comprising removing the shaped cavity to produce a repaired component.

10. The method of claim 8, wherein the shaped cavity comprises a mold shaped to reform the damaged component.

11. The method of claim 8, wherein the repair material comprises a first material and an additive material.

12. The method of claim 8, wherein the repair material comprises a composition of nickel and boron.

13. The method of claim 8, wherein the shaped cavity comprises a same material as the damaged component.

14. The method of claim 8, further comprising applying heat to the shaped cavity such that a first material in the repair material diffuses into the shaped cavity, while a second material in the repair material bonds metalurgically to the damaged component.

15. The method of claim 8, wherein the melting point of the shaped cavity is reduced such that it is capable of melting away from the damaged component.
